(19) United States
(12) Patent Application Publication
(10) Pub. No.: US 2026/0155977 A1
(43) Pub. Date: Jun. 4, 2026

(54) METHOD AND SYSTEM FOR SECURING INFORMATION EXCHANGE AGAINST AI-BASED NETWORK TRAFFIC BY USING CLIENT-SIDE EXECUTION-BASED CHALLENGE-RESPONSE MECHANISMS

(71) Applicant: c/o Radware Ltd., Tel Aviv (IL)

(72) Inventors: Amir MARMOR, Arugot (IL); David AVIV, Tel Aviv (IL)

(73) Assignee: c/o Radware Ltd., Tel Aviv (IL)

(21) Appl. No.: 19/408,104

(22) Filed: Dec. 3, 2025

Related U.S. Application Data
(60) Provisional application No. 63/727,951, filed on Dec. 4, 2024.

(51) Int. Cl. H04L 9/32

(52) U.S. Cl. CPC H04L 9/3213; H04L 9/3271

(57) ABSTRACT

A system and method for defending against AI-driven web traffic interference is provided. The system and method include: receiving, by an agent, a secret device ID and a web token provided by an authentication server; receiving an instruction to modify a request to a web service stored in a web server; embedding within a WebAssembly (WASM) component executed by the agent, a first portion of an encryption key and a second portion of the encryption key; transmitting the second portion of the encryption key to the authentication server; assembling, at runtime within the WASM component, an actual encryption key by combining the first portion and the second portion of the encryption key; encrypting, using the actual encryption key, the web token in the WASM component to generate a plurality of authentication tokens; and sending a request with the generated plurality of authentication tokens to the authentication server.

### CROSS-REFERENCE TO RELATED APPLICATIONS

This application claims the benefit of US Provisional Application No. 63/727,951 filed on Dec. 4, 2024, the contents of which are hereby incorporated by reference.

### TECHNICAL FIELD

This disclosure generally relates to cyber-security and, more particularly, to the mechanisms for securely executing client-side challenges and responses that protect against automated attacks, reverse engineering, and information leakage through browser interactions.

### BACKGROUND

AI-driven interference in digital systems often involves attackers deploying sophisticated AI agents and bot networks to exploit vulnerabilities and overwhelm defenses across multiple layers of web infrastructure. Malicious actors often train these systems using reinforcement learning or feedback loops, allowing them to reverse-engineer application behavior, including token-based authentication schemes like JSON Web Tokens. Once such a token is intercepted or replicated, these systems can replay or manipulate the token in ways that traditional defenses are ill-equipped to detect.

Additionally, some AI-enhanced threats operate by simulating human-like behavior with extreme precision. Bots can intelligently navigate authentication flows, mimic mouse movements and keystrokes, and adapt to client-side challenge-response mechanisms. Because of their adaptive capabilities, these agents can bypass typical JavaScript-based security controls that would stop conventional bots.

In environments relying on session-based security, AI agents can exploit poorly protected session cookies, intercept communications, or reroute traffic in real time using machine-speed decision making. AI agents may insert themselves silently into active sessions, extract valuable tokens, and propagate their access across distributed systems.

For example, one type of AI-driven interference is session hijacking, where attackers intercept and exploit a user's active session to gain account access. This type of attack includes stealing session cookies using malware or sniffing tools. Once the session cookie is obtained, the attacker bypasses the login process. Hijacking the cookie would allow the attacker to obtain immediate access to the victim's account without needing credentials.

Another type of AI-driven interference is Man-in-the-Middle (MitM) or replay attacks. In this attack, attackers intercept communications between the user and a website or application. An attacker executes this attack via an insecure public Wi-Fi network, where login details are intercepted to gain unauthorized access.

Therefore, it would be advantageous to provide a solution that would cure the deficiencies noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include receiving, by an agent, a secret device identifier (ID) and a web token provided by an authentication server, where the agent is executed in a web browser. The method may also include receiving an instruction to modify a request to a web service stored in a web server, where the web service is a protected entity. The method may furthermore include embedding, in a masked and compiled manner within a WebAssembly (WASM) component executed by the agent, a first portion of an encryption key and a second portion of the encryption key. The method may in addition include when a service worker in the web browser attempts to transmit the request to the web service, transmitting the second portion of the encryption key to the authentication server. The method may moreover include assembling, at runtime within the WASM component, an actual encryption key by combining the first portion and the second portion of the encryption key. The method may also include encrypting, using the actual encryption key, the web token in the WASM component to generate a plurality of authentication tokens, where each authentication token is based, in part, on a random seed generated by the WASM component executed in the agent, and where one authentication token of the plurality of authentication tokens includes at least a valid random seed; and sending a request with the generated plurality of authentication tokens to the authentication server, where the request, including a session cookie, is validated by the authentication server before being relayed to the web server. Other embodiments of this aspect include corresponding computer systems, apparatus, and computer programs recorded on one or more computer storage devices, each configured to perform the actions of the methods.

Implementations may include one or more of the following features. The method may include: segmenting the secret device ID, web token, random seed, and a browser location into sections; and including the segmented sections across the plurality of authentication tokens, where the segmented sections are included in different authentication tokens. The method may include: including the plurality of generated authentication tokens in the session cookie in the request sent to the web service. Method may include: including the plurality of generated authentication tokens in a header of the request, where the request is an HTTP/s request. The method may include: communicating the plurality of generated authentication tokens to the authentication server. The method may be performed in response to a successful login by an user of the web browser to the web server. The method may include the following: the received secret device ID and the web token are encrypted. The method may include: decrypting the received secret device ID and the web token using a symmetric key. The method may include: generating a new plurality of authentication tokens for each new request. The method may include the following: the plurality of generated authentication tokens are ephemeral. The method may include: encrypting, using a symmetric key, the plurality of generated authentication tokens as the session cookie. Validating the request, as part of the method, further may include: decrypting, using the symmetric key, the session cookie;
comparing contents of the session cookie to information maintained by the authentication server, where the random seed included in the session cookie is compared to random seeds previously identified by the authentication server; and determining the session cookie to be valid when the contents of the session cookie match the information maintained by the authentication server. The method may include the following: the contents of the session cookie are a result of a challenge, where a challenge includes at least a behavioral action by the browser. The method may include: receiving a message forcing an user to re-log in when the session cookie is determined to be invalid. The method include the following: the request is at least an HTTP request directed to a web service hosted by the web server, where the web service is a protected entity. The method may include the following: embedding the first portion of the encryption and the second portion of the encryption key in a masked and compiled manner prevents the first portion and the second portion from being statically read within the WASM component. Implementations of the described techniques may include hardware, a method or process, or a computer tangible medium.

In one general aspect, non-transitory computer-readable medium may include one or more instructions that, when executed by one or more processors of a device, cause the device to: receive, by an agent, a secret device identifier (ID) and a web token provided by an authentication server, where the agent is executed in a web browser; receive an instruction to modify a request to a web service stored in a web server, where the web service is a protected entity; embed, in a masked and compiled manner within a WebAssembly (WASM) component executed by the agent, a first portion of an encryption key and a second portion of the encryption key; when a service worker in the web browser attempts to transmit the request to the web service, transmit the second portion of the encryption key to the authentication server; assemble, at runtime within the WASM component, an actual encryption key by combining the first portion and the second portion of the encryption key; encrypt, using the actual encryption key, the web token in the WASM component to generate a plurality of authentication tokens, where each authentication token is based, in part, on a random seed generated by the WASM component executed in the agent, and where one authentication token of the plurality of authentication tokens includes at least a valid random seed; and send a request with the generated plurality of authentication tokens to the authentication server, where the request, including a session cookie, is validated by the authentication server before being relayed to the web server. Other embodiments of this aspect include corresponding computer systems, apparatus, and computer programs recorded on one or more computer storage devices, each configured to perform the actions of the methods.

In one general aspect, a system may include one or more processors configured to: receive, by an agent, a secret device identifier (ID) and a web token provided by an authentication server, where the agent is executed in a web browser; receive an instruction to modify a request to a web service stored in a web server, where the web service is a protected entity; embed, in a masked and compiled manner within a WebAssembly (WASM) component executed by the agent, a first portion of an encryption key and a second portion of the encryption key; when a service worker in the web browser attempts to transmit the request to the web service, transmit the second portion of the encryption key to the authentication server; assemble, at runtime within the WASM component, an actual encryption key by combining the first portion and the second portion of the encryption key; encrypt, using the actual encryption key, the web token in the WASM component to generate a plurality of authentication tokens, where each authentication token is based, in part, on a random seed generated by the WASM component executed in the agent, and where one authentication token of the plurality of authentication tokens includes at least a valid random seed; and send a request with the generated plurality of authentication tokens to the authentication server, where the request, including a session cookie, is validated by the authentication server before being relayed to the web server. Other embodiments of this aspect include corresponding computer systems, apparatus, and computer programs recorded on one or more computer storage devices, each configured to perform the actions of the methods.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 shows an example network diagram utilized to describe the various disclosed embodiments.

FIG. 2 is an example schematic diagram illustrating components and functions of a disclosed embodiment.

FIG. 3 is a flow diagram demonstrating a process of defending against AI-driven interference according to an embodiment.

FIG. 4 is a flowchart of an example process for defending against AI-driven interference according to an embodiment.

FIG. 5 shows an example flowchart illustrating a process for validating a request from a browser according to an embodiment.

FIG. 6 is an example block diagram of a hardware architecture of a compute device according to an embodiment.

### DETAILED DESCRIPTION

The embodiments disclosed herein are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The disclosed embodiments present a method and system to protect web services and web access from AI-driven interference. The disclosed method and system include a novel client-side execution mechanism that allows secure information exchange and challenge processing in a browser environment. The method and system are resistant to static analysis and automated reverse engineering by using dynamically generated code in non-standard formats, complex runtime decryption of secrets, and multiple cryptographic layers. The disclosed embodiments allow defense against various types of automated attacks, including, but not limited to, credential stuffing or credential theft, phishing-based attacks, session hijacking, MitM attacks, SIM-swapping-enabled password resets, malware-driven credential theft, replay attacks, and the like. Other types of attacks include account enumeration (identifying valid accounts without accessing them), man-in-the-middle interception that does not yet yield control of an account, and business email compromise variants that rely on impersonation rather than direct credential compromise. The disclosed embodiments further allow defense against automated attacks that are capable of reverse engineering traditional security mechanisms by examining static code, simulating browser environments, or automating scripts.

The disclosed embodiments enhance the security of protected entities by blocking or preventing AI-based, automated interference (hereinafter, AI-driven web traffic interference or AI-driven interference) through the use of client-side challenge-response mechanisms. The challenge-response mechanisms are executed at the client-side as opposed to the web server being protected, which improves the web server's overall performance. By executing the novel challenge-response mechanisms outside of the web server, the disclosed embodiments reduce the demand for computational resources on the server. The web server may include any protected resources, such as a device, a service, an application, a file, an object, and the like, that may be exploited using an automated AI-driven interference.

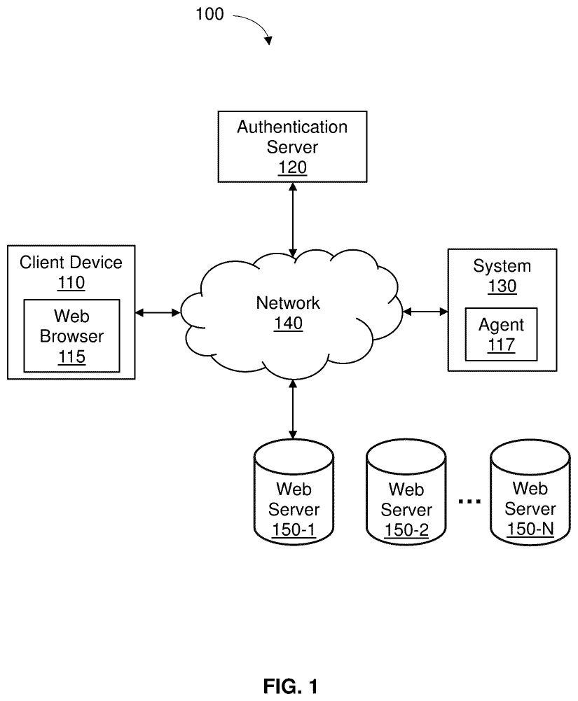

FIG. 1 shows an example network diagram 100 utilized to describe the various disclosed embodiments. Web services accessed by a user's device, and hence the user, are protected against AI-driven interference.

The network diagram 100 illustrated in FIG. 1 includes a client device 110 (or simply client 110), an authentication server 120, and web server 150-1 through 150-N (hereinafter web server 150 or server 150 in the singular or web servers 150 or server 150 in the plural), all connected to network 140. Client 110 may be a PC, a mobile phone, a smartphone, a tablet computer, a server, or any compute device, and the like. Client 110 typically includes a processor and a memory that can be configured to execute script codes, software, HTTP/S pages, and the like.

Client 110 may be operated by a legitimate user or a legitimate program. In one configuration, client 110 is configured to execute a web browser 115 (hereinafter, web browser 115 or browser 115). Browser 115 is configured to include any software application to access the content stored on or accessible through the web server 150.

Web server 150 may include a web server, a streaming server, a database server, or any other type of servers that provide content or information to client 110 via browser 115. For example, web server 150 is configured to host a website for browser 115 to render and display web pages of that website on the client 110. Web server 150 is configured to also host a web application providing web services. In a non-limiting embodiment, web services hosted in server 150 are the protected entities, such as, but not limited to, a service, an application, an object, a file, a library of files, a device, and the like. For example, a protected web service may be a bank account.

Client 110 is configured to send a request to web server 150. A request may include an HTTP request. Such an HTTP request is a message sent from client 110, typically via a web browser or application, to web server 150 to retrieve or submit information over the web. The HTTP request includes an HTTP method (e.g., GET or POST), a target resource URL, and an HTTP version; headers whose key-value pairs provide metadata about the request, such as the client's browser type, accepted content types, and authentication details; and a body which includes data sent to the server, such as form inputs (used mainly with methods like POST). Web server 150 processes the request and sends back an HTTP response with the requested resource, status code, or an error message. The headers of an HTTP request carry a session cookie (hereinafter session cookie or session token). A session cookie is used in HTTP to maintain stateful interactions between client 110 and web server 150 during a session.

System 130 is configured to deploy authenticator agent 117 (hereinafter, agent 117 for simplicity) on browser 115 to defend against AI-driven interference. To this end, agent 117 is configured to be loaded to browser 115 and activated after a user successfully logs in or authenticates to a web service hosted by web server 150. Login may be done through a passkey or multi-factor authentication (MFA). A passkey is a modern, secure way to log in to apps and websites without needing a traditional password. A passkey uses public-key cryptography, offering a simpler and more secure alternative to passwords. Passkeys are resistant to phishing, credential theft, and other forms of cyberattacks.

Agent 117 is configured to generate an authentication token and to enter the authentication token as the header of an HTTP/HTTPS request as a cookie session or token. In an alternative embodiment, a token can be included in the header, not as a header. As discussed below, the generated authentication token includes, but is not limited to, a web token (such as a JSON web token (JWT)), a secret device ID, a random seed, and a browser location (e.g., a domain name). The web token provides a user context (e.g., from a JWT claim) and evidence of a secure session. The web token is encrypted to prevent session hijacking attacks. The secret device ID prevents Man-in-the-Middle (MitM) or replay attacks by forcing requests to utilize browser-specific data (e.g., a secret key), the random seed prevents replay attacks, and the browser location prevents transparent phishing attacks. The web token and secret device ID are provided by authentication server 120. The generation of the authentication token is discussed in greater detail below.

According to the disclosed embodiments, the authentication token is encrypted by browser 115 and decrypted by authentication server 120. In one embodiment, a symmetric key is used for the encryption and decryption of the authentication token. A symmetric key is a type of cryptographic key used in symmetric encryption, where the same key is used for both encrypting and decrypting information. The encryption and decryption of authentication tokens may be achieved using other techniques, including, but not limited to, hash functions, asymmetric encryption algorithms, secure hash algorithms (SHA), and the like. The encryption algorithms being utilized may be different from one agent to another. For example, two different agents running on different browsers may not execute the same encryption algorithm.

In some embodiments, agent 117 is configured to generate a plurality of authentication tokens. Authentication tokens generated by agent 117 are ephemeral tokens that cannot be discovered or tampered with in any process executed on client 110. For example, according to an embodiment, any script running on client 110 cannot execute code to intercept the generated authentication tokens. Each authentication token generated by agent 117 is encrypted and added, as a session token, to any request sent from browser 115 to web server 150. This ensures that the session token cannot be discovered by any malware or hacker. Additionally, authentication tokens used in any transaction, such as encrypting a browser-generated challenge response, is ephemeral, limiting the viability of reverse engineering by an AI agent even if the AI agent gains temporary access.

As the secrets used to generate an authentication token, discussed in more detail below, are not stored in browser 115, malware operating on client 110 cannot regenerate the authentication token.

In some embodiments, secrets (e.g., encryption keys or tokens) are dynamically split into multiple components and reassembled only at runtime within the executing browser 115. In an embodiment, the secrets are fragmented across a plurality of authentication tokens. These embodiments make interception or extraction by attackers using AI agents capable of analyzing static code impractical. Additionally, as the secrets are reassembled at runtime in the browser 115, only at the time of execution can the appropriate response to a challenge encrypted in the authentication token be generated, preventing an attacker from pre-computing the response or conducting a replay attack. For example, fragments of the token are distributed across different parts of the client-side code and come together as a complete token only when specific runtime conditions are met in the runtime logic. The reassembled token exists briefly in memory during active execution within a legitimate browser environment, making it difficult for attackers to intercept or reconstruct the token outside the legitimate browser context.

In additional embodiments, several encryption tokens may be used in parallel with only one token containing the valid secret that is to be decrypted by the browser 115. According to this embodiment, multiple encrypted tokens are included, and each token appears to the browser 115 as equally plausible to contain the valid token. Each token may be encrypted using different algorithms, keys, or encoding methods. The correct token is chosen based on runtime logic that is hidden in a bytecode format (e.g., WebAssembly format) on the browser 115. A legitimate client, using runtime logic, identifies and processes the correct token. This multilayer encryption obfuscates the valid secret, ensuring unauthorized decryption efforts are prevented.

It should be noted that agent 117 is a piece of software code executed over the client (e.g. client 110). Agent 117 may be realized often as just-in-time compiled software code. Software shall be construed broadly to include any instructions. Instructions may include code (e.g., in source code format, binary code format, executable code format, or any other suitable format of code). The instructions, when executed, cause the processing circuitry (e.g., circuitry embedded in the client 110) to perform the various functions or processes of the agent 117.

In an embodiment, authentication server 120 is configured to validate authentication tokens generated by agent 117. If an authentication token is validated, the request to access a web service is passed to web server 150. Then, a new time-to-live (TTL) value is generated and provided to agent 117 to allow the generation of a new authentication token. If the validation of the authentication token is rejected by the authentication server 120, a new login by the user is enforced. The operation of the authentication server 120 is discussed in detail below.

It should be noted that although one client 110, one authentication server 120, one system 130, and one agent 117 are illustrated in FIG. 1 for the sake of simplicity, the embodiments disclosed herein can be applied to a plurality of clients, a plurality of authentication servers, a plurality of web servers or services acting as protected entities, or any combination of thereof. The clients 110 may be in different geographical locations.

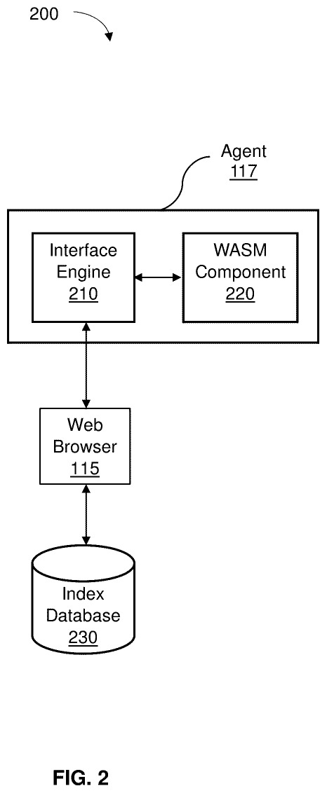

FIG. 2 is an example schematic diagram 200 illustrating components and functions of a disclosed embodiment.

In an embodiment, agent 117 may include an interface engine 210 and a WebAssembly (WASM) component 220. Interface engine 210 interfaces with web browser 115 and further controls the requests to be modified to include the authentication token. For example, requests not directed to a protected entity will not be modified. Interface engine 210 also encrypts an authentication token and decrypts information (such as a web token and a secret device ID) received from authentication server 120 (through browser 115). Interface engine 210 can be realized as a piece of script code. Browser 115 and agent 117 are depicted separately in schematic diagram 200 for the sake of simplicity.

WASM component 220 is a binary instruction format designed to serve as a portable, low-level code that can be executed in modern web browsers at near-native speed, such as Chrome®, Edge®, Firefox®, Safari®, and the like. WASM component 220 is a highly efficient, compact, and secure way to run code written in languages other than JavaScript (C, C++, Rust, and others) on the web.

In an embodiment, WASM component 220 is configured to generate runtime parameters (e.g., secrets or random numbers) that are encoded in a representation (e.g., bytecode) other than traditional scripts (e.g., JavaScript), which obfuscates the function of the runtime parameters until runtime execution. WASM component 220 is configured to send the generated runtime parameters to the interface engine 210, which then includes the runtime parameters in the authentication token in the request that the interface engine 210 is configured to modify. Such runtime parameters are inaccessible by an AI agent attempting to conduct an AI-driven interference. The inaccessible runtime parameters also cannot be modified by other processes running on a client device (e.g., client device 110, FIG. 1). Such other processes include, but are not limited to, browser 115. Further, the runtime parameters generated by WASM component 220 do not access the I/O memory of a client device, providing another layer of security protection.

In some embodiments, the secrets contained in the runtime parameters generated by WASM component 220 are distributed across multiple tokens, ensuring that an AI agent is unable to analyze static code to bypass security checks. In additional embodiments, various secret of the runtime parameters generated by WASM component 220 may be encrypted, where some of the secrets are not valid for the encryption-decryption information exchange and only one is the valid secret.

In an embodiment, WASM components 220 can differ from one agent to another. For example, two agents running on different browsers may not execute the same version of WASM components 220. Different WASM components 220 may have different code implementations.

Browser 115 is configured to maintain an index database 230. Index database 230 is a low-level, client-side database application programming interface (API) in modern web browsers. Index database 230 allows developers to store and retrieve large amounts of structured data, including, but not limited to, files and blobs directly in the browser 115. According to an embodiment, a user entity, as derived from the web token, is stored in the index database 230.

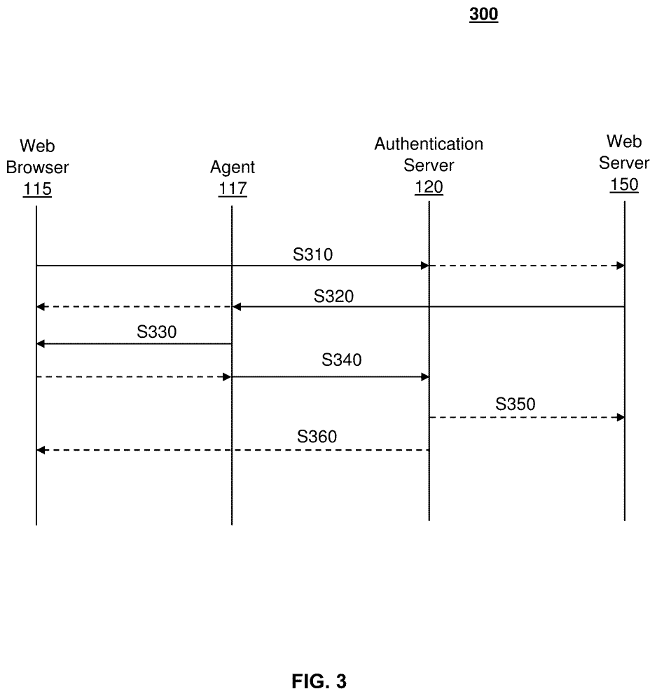

FIG. 3 is a flow diagram 300 demonstrating a process of defending against AI-driven interference according to an embodiment. Illustrated in FIG. 3 are web browser 115, agent 117, authentication server 120, and web server 150. These elements have been discussed in detail above with reference to FIG. 1. In flow diagram 300, web server 150 is the protected entity.

At S310, a user of browser 115 navigates to a web service hosted by web server 150. For example, the user navigates to an online bank account. Navigating to the online bank account requires the user to send a log in request to the web service (e.g., the online bank account). Such a login request can be typically performed by providing login credentials including, but not limited to, a username and password, passkey, MFA, a combination thereof, and the like. In an embodiment, the login request may be relayed to web server 150 by the authentication server 120.

At S320, web server 150 sends an acknowledgment message to agent 117 upon a successful login. Such an acknowledgement message may include a web token. A web token, such as a JWT (JSON Web Token), is a compact, secure, and self-contained way to represent data and is often used for authentication and session management in web applications. A web token includes, but is not limited to, a header, metadata about the token (e.g., a signing algorithm), a payload, claims or data being transmitted (e.g., {“userId”:123, “role”:“dmin”}), and a signature, which ensures the token has not been tampered with. In an embodiment, the acknowledgment message may be relayed to web browser 115 by agent 117.

In an embodiment, authentication server 120 generates a user entity and a secret device ID. The secret device ID is attached to the user entity. In an embodiment, the secret device ID is a precise text random number. The secret device ID is encoded, for example, by a symmetric key before being sent to browser 115. Browser 115 stores the secret device ID in an index database (e.g., index database 230, FIG. 2) of browser 115. It should be noted that the authentication server 120 generates a user entity if such a user entity does not exist. The user entity is created from a web token. In an example embodiment, if the web token is a JWT, as demonstrated above, the user ID is “123”.

At S330, upon successful authentication, agent 117 is downloaded to browser 115. Agent 117 is downloaded to browser 115 under the control of authentication server 120. As noted above, agent 117 includes WASM component 220.

In an embodiment, agent 117, via the WASM component, generates an authentication token. As noted above, such a token includes, but is not limited to, a secret device ID, a web token, a random seed, and a browser location. The random seed is generated by the WASM component, which does not access or store any information in the browser, ensuring protection against a hacker attempting to copy the random seed.

It should be noted that a new authentication token is generated for every request. In some embodiments, agent 117 is configured to generate such authentication tokens for each request. However, it should be emphasized that a generated authentication token cannot be reused for different requests.

In an embodiment, the generated authentication token is used as a session cookie. In another embodiment, the generated authentication token is included in the header and not in the token. In yet another embodiment, the authentication token can be sent back to the authentication server using indirect communication, using, for example, SDK-less implementation. The authentication token, which includes a random seed, a web token, a secret device ID, a browser location, and other key authentication information, is encrypted using a symmetric key before being sent to authentication server 120.

In some embodiments, the generated authentication token is split into multiple authentication tokens that are reassembled at runtime execution at the client 110 in browser 115, preventing an AI agent from reverse engineering only one authentication token to gain access to authentication information. In additional embodiments, multiple authentication tokens are used, where each authentication token includes secrets such as a random seed, secret device ID, web token, and browser location, but only one authentication token contains the valid secret elements (e.g., random seed, web token, secret device ID, and browser location) that were generated by the authentication server.

It should be noted that although S320 and S330 are shown as occurring at different times, they can be performed in parallel. Both steps occur upon a successful user login.

At S340, the authentication server 120 validates the request and, specifically, the authentication token included therein. If the authentication token is valid, the request to access a protected entity is authorized. Validating the authentication token includes checking if each of the secret elements of the token (e.g., random seed, web token, secret device ID, and browser location) is validated and correct. The embodiments for validating the authentication token are discussed below.

At S350, if the authentication token is determined to be valid, the request sent from browser 115 is passed from the authentication server 120 to web server 150. Otherwise, at S360, authentication server 120 forces the user to log in again at browser 115.

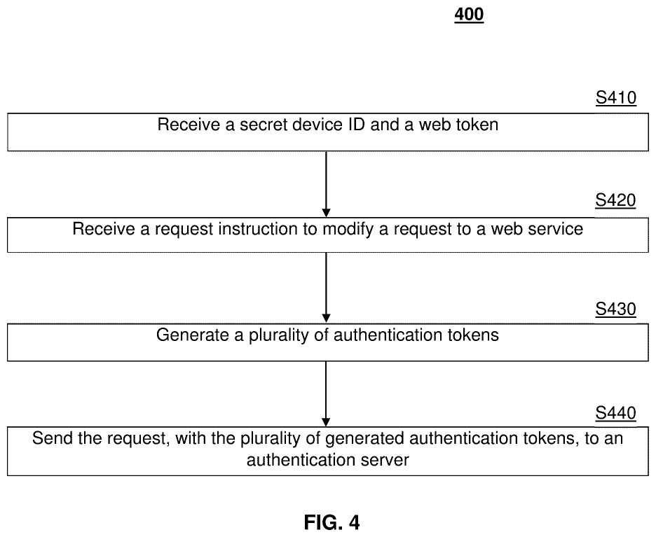

FIG. 4 is a flowchart of an example process 400 for defending against AI-driven interference according to an embodiment. In some implementations, one or more process blocks of FIG. 4 may be performed by an agent (e.g. agent 117, FIG. 1) executed on a client device (e.g., client device 110, FIG. 1). Prior to the execution of the method, a WASM component (e.g. WASM component 220, FIG. 2) is downloaded to the client device's browser (e.g., web browser 115).

At S410, a secret device ID and a web token are received. The secret device ID and a web token are sent by an authentication server. The web token is received from a web server at the authentication server in response to a successful login by the user. In an embodiment, the secret device ID and a web token are encrypted.

At S420, a request instruction to modify a request to a web service is received. In an embodiment, the web service is the protected entity. In an embodiment, the agent is configured with web services for each request that is to be modified. A request may include, for example, an HTTP or an HTTPS request. In some embodiments, the request instruction is sent from an interface engine (e.g., interface engine 210) of the agent and includes the authentication token in the request that is to be modified.

At S430, a plurality of authentication tokens is generated. In an embodiment, the generated plurality of authentication tokens is ephemeral. In another embodiment, a new plurality of authentication tokens is generated for each new request. Generating an authentication token is described in detail herein. In some embodiments, each authentication token of the plurality of authentication tokens is based, in part, on a random seed that is generated by a WASM component executed in an agent. According to this embodiment, one authentication token of the plurality of authentication tokens includes a valid random seed, and the other authentication tokens of the plurality of authentication tokens include random seeds that are not valid and are not maintained by the authentication server for the specific request. Including a plurality of authentication tokens where one contains the valid random seed serves to provide multiple layers of encryption, making it difficult for an AI-driven interference to reverse engineer the session cookie to gain access to an account.

In some embodiments, secret elements such as, but not limited, a secret device ID, web token, random seed, and a browser location are included in the plurality of authentication tokens, where each authentication token includes secret elements, but one authentication token includes valid secret elements known to the authentication server for a specific request. In some embodiments, each secret element mentioned above is segmented into sections and fragmented across the plurality of authentication tokens, where the segmented sections are included in different authentication tokens. The segmented secret elements are reassembled upon execution of the browser logic, making the secret elements more secure against an AI-driven interference.

At S440, the request, with the plurality of generated authentication tokens, is sent to the authentication server. In an embodiment, the plurality of authentication tokens may be included in a session cookie. In another embodiment, the plurality of authentication tokens is included as a header of an HTTP request. In some embodiments, the request is validated by the authentication server before being relayed to the web server.

In some embodiments, validation of the request includes encrypting, using a symmetric key, the plurality of generated authentication tokens as the session cookie for the request. The session cookie is then decrypted using the symmetric key. Decrypting the session cookie includes making the contents of the session cookie readable. The contents of the session cookie are compared to information maintained by the authentication server. For example, the random seed included in the session cookie is compared to random seeds previously identified by the authentication server. Then, according to this embodiment, it is determined whether the session cookie is valid. When the contents of the session cookie match the information maintained by the authentication server, the session cookie is deemed valid. Validation of the session cookie is discussed in more detail below.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

It should be appreciated that in certain embodiments, a method for defending against AI-driven web traffic interference is implemented by an agent executed within a web browser. The agent receives, from an authentication server, both a secret device identifier (ID) and a web token that are bound to the specific browser instance. The agent further receives an instruction to modify a request directed to a protected web service hosted on a web server.

A WASM component executed by the agent contains, in its compiled binary, two masked portions of an encryption key. These key portions are embedded such that their raw values cannot be extracted by static inspection of the WASM module. Instead, each portion remains obfuscated until selectively reconstructed during runtime.

When a service worker operating within the browser attempts to transmit the modified request to the protected web service, the service worker transmits the second portion of the encryption key to the authentication server. The WASM component then executes a runtime assembly process in which the first portion and the second portion of the encryption key are programmatically combined to derive an actual operational encryption key. Because this assembly occurs entirely within the WASM execution environment and only after the second portion is received at runtime, the complete encryption key is never exposed externally or stored in an unmasked form.

Using the assembled encryption key, the WASM component encrypts the provided web token to generate a plurality of encrypted authentication tokens. The WASM component also generates, for each authentication token, a corresponding random seed produced internally by WASM-based cryptographic functionality. Among the plurality of generated authentication tokens, at least one includes a valid random seed suitable for validation by the authentication server, while additional tokens may serve as decoys to impede automated traffic analysis or interference.

The agent sends a request containing the plurality of authentication tokens, along with a session cookie, to the authentication server. The authentication server validates the request, including verification of the correct encrypted token and valid random seed, before relaying the authenticated request to the protected web server. Because only a properly assembled encryption key and valid WASM-generated random seed produce acceptable authentication material, the method mitigates attempts by AI-driven systems to forge or manipulate web traffic.

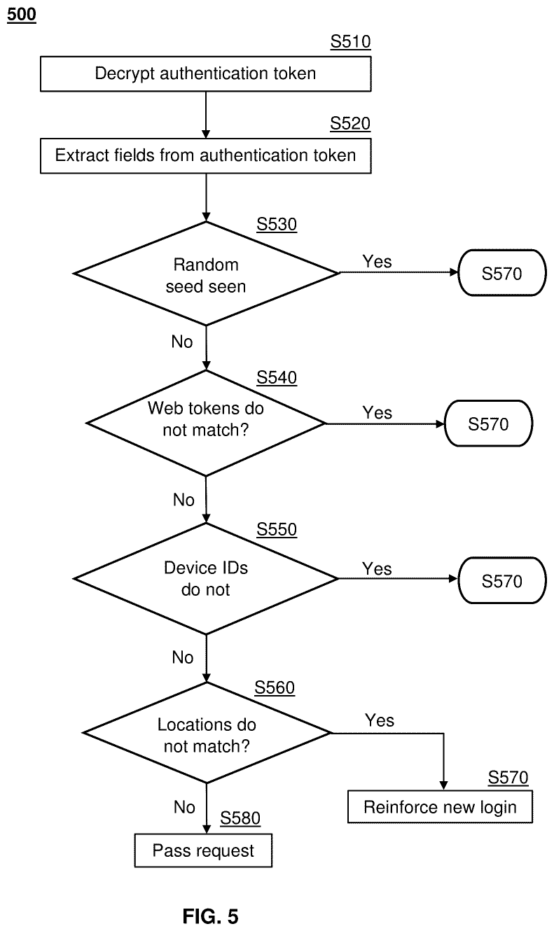

FIG. 5 shows an example flowchart 500 illustrating a process for validating a request from a browser according to an embodiment. In an embodiment, the process is performed by an authentication server (e.g. authentication server 120). The request includes an authentication token generated as discussed above. The token may be included in a session cookie, as part of the request's header, or indirect communication with an authentication server in some implementations, such as SDK-less.

At S510, the authentication token is decrypted. In an embodiment, the decryption is performed using the symmetric key that was utilized to encrypt the token by the WASM component. In an embodiment, the authentication token is extracted from a request before it is decrypted.

At S520, the various fields of the authentication token are extracted. Note that such fields are in clear text as the token is decrypted. For the sake of explanation and without limitation, such fields will be referred to as a random seed, a secret device, a web token, and a browser location.

In some embodiments, the contents of the fields are the result of a challenge as part of a challenge-response mechanism. Such a challenge-response mechanism includes sending a behavioral challenge embedded in the session cookie in a request. The browser performs the challenge, and if the results of the challenge match the expected results, then the session cookie is valid. For example, the challenge may be to move the cursor to a specific coordinate on a web page known to the authentication server. If the browser coordinate that the cursor navigates to is the same coordinate as the one maintained by the authentication server, then the session cookie is valid.

At S530, it is checked if the random seed was previously seen by the authentication token. As noted above, the authentication server stores all random seeds in previously validated messages. If S530 results in a yes answer, the request is invalid and execution continues with S570; otherwise, execution continues with S540.

At S540, it is checked if the web token does not match as the web token sent to the browser by the authentication server at the beginning of the session. If S540 results in a yes answer, the request is invalid and execution continues with S570; otherwise, execution continues with S550.

At S550, it is checked if the secret device ID does not match a secret device ID sent to the browser by the authentication server at the beginning of the session. If S550 results in a yes answer, the request is invalid, and execution continues with S570; otherwise, execution continues with S560.

At S560, it is checked if the browser location does not match the browser location of the protected web service. If S560 results in a yes answer, the request is invalid, and execution continues with S570; otherwise, execution continues with S580.

At S570, the request is determined to be invalid, and a message is sent to the browser forcing it to perform a new login process to the protected web services.

At S580, the request is determined to be valid, and thus the request is sent to the web server 150.

In some embodiments, if a number of failed attempts to validate requests from a specific browser occur, the user device may be blocked from accessing the protected web service. Further, a report may be sent to the protected entity's security team.

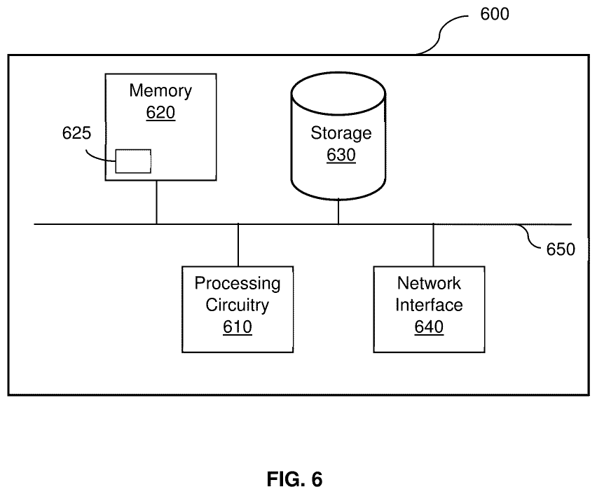

FIG. 6 is an example block diagram of a hardware architecture 600 of a compute device 600. In an embodiment, the client device 110, the system 130, and the authentication server 120 can be realized using the hardware architecture 700.

The hardware architecture 600 includes a processing circuitry 610 coupled to a memory 620, a storage 630, and a network interface 640. In an embodiment, the components of the client device 110 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), graphics processing units (GPUs), system-on-a-chip systems (SOCs), general-purpose microprocessors, microcontrollers, digital signal processors (DSPs), and the like, or any other hardware logic components that can perform calculations or other manipulations of information. In an embodiment, the processing circuitry 610 (or the entire system 110) may be implemented as a Turing machine over the blockchain network.

The memory 620 may be volatile (e.g., RAM, etc.), non-volatile (e.g., ROM, flash memory, etc.), or any combination thereof. In one configuration, computer-readable instructions needed to implement one or more embodiments disclosed herein may be stored in the storage 630.

In another embodiment, the memory 620 is configured to store software. Software shall be construed broadly to mean any type of instructions, whether referred to as software, firmware, middleware, microcode, or hardware description language. Instructions may include code (e.g., in source code format, binary code format, executable code format, or any other suitable format of code). The instructions, when executed by the one or more processors, cause the processing circuitry 610 to perform the various processes described herein. Specifically, the instructions, when executed, cause the processing circuitry 610 to generate identity key(s) by executing the script code as discussed above. In a further embodiment, the memory 620 may further include a memory portion 625 including the instructions.

The storage 630 may be magnetic storage, optical storage, and the like, and may be realized, for example, as flash memory or other memory technology, CD-ROM, Digital Versatile Disks (DVDs), hard drives, SSD, or any other medium which can be used to store the desired information, such as log of transactions, public keys, and so on. The storage 630 may include various access policies and games.

The network interface 640 allows the client device 110 to communicate with the blockchain network, the Internet, or a local area network. The network interface 640 furthers peer-to-peer communication with these elements.

It should be understood that the embodiments described herein are not limited to the specific architecture illustrated in FIG. 6 and that other architectures may be equally used without departing from the scope of the disclosed embodiments.

It should be further noted that the client device 110 and the authentication server 120 may be realized using a computing architecture similar to the architecture illustrated in FIG. 6, but that other architectures may be equally used without departing from the scope of the disclosed embodiments. Further, the memory 620 may include instructions for executing the function of the respective device, e.g., a client device 110.

The various embodiments disclosed herein can be implemented as any combination of hardware, firmware, and software. Moreover, the software is preferably implemented as an application program tangibly embodied on a program storage unit or computer-readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and a microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

It should be understood that any reference to an element herein using a designation such as “first,” “second,” and so forth does not generally limit the quantity or order of these elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements. In addition, terminology of the form “at least one of A, B, or C” or “one or more of A, B, or C” or “at least one of the groups consisting of A, B, and C” or “at least one of A, B, and C” used in the description or the claims means “A or B or C or any combination of these elements.” For example, this terminology may include A, or B, or C, or A and B, or A and C, or A and B and C, or 2A, or 2B, or 2C, and so on.

All examples and conditional language recited herein are intended for pedagogical purposes to aid the reader in understanding the disclosed embodiments and the concepts contributed by the inventor to further the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for defending against AI-driven web traffic interference, comprising:
receiving, by an agent, a secret device identifier (ID) and a web token provided by an authentication server, wherein the agent is executed in a web browser;
receiving an instruction to modify a request to a web service stored in a web server, wherein the web service is a protected entity;
embedding, in a masked and compiled manner within a WebAssembly (WASM) component executed by the agent, a first portion of an encryption key and a second portion of the encryption key;
when a service worker in the web browser attempts to transmit the request to the web service, transmitting the second portion of the encryption key to the authentication server;
assembling, at runtime within the WASM component, an actual encryption key by combining the first portion and the second portion of the encryption key;
encrypting, using the actual encryption key, the web token in the WASM component to generate a plurality of authentication tokens, wherein each authentication token is based, in part, on a random seed generated by the WASM component executed in the agent, and wherein one authentication token of the plurality of authentication tokens includes at least a valid random seed; and
sending a request with the generated plurality of authentication tokens to the authentication server, wherein the request, including a session cookie, is validated by the authentication server before being relayed to the web server.

2. The method of claim 1, further comprising:
segmenting the secret device ID, web token, random seed, and a browser location into sections; and
including the segmented sections across the plurality of authentication tokens, wherein the segmented sections are included in different authentication tokens.

3. The method of claim 1, further comprising: including the plurality of generated authentication tokens in the session cookie in the request sent to the web service.

4. The method of claim 1, further comprising: including the plurality of generated authentication tokens in a header of the request, wherein the request is an HTTP/s request.

5. The method of claim 1, further comprising: communicating the plurality of generated authentication tokens to the authentication server.

6. The method of claim 1, wherein the method is performed in response to a successful login by a user of the web browser to the web server.

7. The method of claim 1, wherein the received secret device ID and the web token are encrypted.

8. The method of claim 7, further comprising:
decrypting the received secret device ID and the web token using a symmetric key.

9. The method of claim 1, further comprising:
generating a new plurality of authentication tokens for each new request.

10. The method of claim 1, wherein the plurality of generated authentication tokens are ephemeral.

11. The method of claim 1, further comprising:
encrypting, using a symmetric key, the plurality of generated authentication tokens as the session cookie.

12. The method of claim 11, wherein validating the request further comprises:
decrypting, using the symmetric key, the session cookie;
comparing contents of the session cookie to information maintained by the authentication server, wherein the random seed included in the session cookie is compared to random seeds previously identified by the authentication server; and
determining the session cookie to be valid when the contents of the session cookie match the information maintained by the authentication server.

13. The method of claim 12, wherein the contents of the session cookie are a result of a challenge, wherein a challenge includes at least a behavioral action by the browser.

14. The method of claim 12, further comprising:
receiving a message forcing a user to re-log in when the session cookie is determined to be invalid.

15. The method of claim 1, wherein the request is at least an HTTP request directed to a web service hosted by the web server, wherein the web service is a protected entity.

16. The method of claim 1, wherein embedding the first portion of the encryption and the second portion of the encryption key in a masked and compiled manner prevents the first portion and the second portion from being statically read within the WASM component.

17. A non-transitory computer-readable medium storing a set of instructions for defending against AI-driven web traffic interference, the set of instructions comprising:
one or more instructions that, when executed by one or more processors of a device, cause the device to:
receive, by an agent, a secret device identifier (ID) and a web token provided by an authentication server, wherein the agent is executed in a web browser;
receive an instruction to modify a request to a web service stored in a web server, wherein the web service is a protected entity;
embed, in a masked and compiled manner within a WebAssembly (WASM) component executed by the agent, a first portion of an encryption key and a second portion of the encryption key;
when a service worker in the web browser attempts to transmit the request to the web service, transmit the second portion of the encryption key to the authentication server;
assemble, at runtime within the WASM component, an actual encryption key by combining the first portion and the second portion of the encryption key;
encrypt, using the actual encryption key, the web token in the WASM component to generate a plurality of authentication tokens, wherein each authentication token is based, in part, on a random seed generated by the WASM component executed in the agent, and wherein one authentication token of the plurality of authentication tokens includes at least a valid random seed; and
send a request with the generated plurality of authentication tokens to the authentication server, wherein the request, including a session cookie, is validated by the authentication server before being relayed to the web server.

18. A system for defending against AI-driven web traffic interference comprising:
one or more processors configured to:
receive, by an agent, a secret device identifier (ID) and a web token provided by an authentication server, wherein the agent is executed in a web browser;
receive an instruction to modify a request to a web service stored in a web server, wherein the web service is a protected entity;
embed, in a masked and compiled manner within a WebAssembly (WASM) component executed by the agent, a first portion of an encryption key and a second portion of the encryption key;
when a service worker in the web browser attempts to transmit the request to the web service, transmit the second portion of the encryption key to the authentication server;
assemble, at runtime within the WASM component, an actual encryption key by combining the first portion and the second portion of the encryption key;
encrypt, using the actual encryption key, the web token in the WASM component to generate a plurality of authentication tokens, wherein each authentication token is based, in part, on a random seed generated by the WASM component executed in the agent, and wherein one authentication token of the plurality of authentication tokens includes at least a valid random seed; and
send a request with the generated plurality of authentication tokens to the authentication server, wherein the request, including a session cookie, is validated by the authentication server before being relayed to the web server.

19. The system of claim 18, wherein the one or more processors are further configured to:
segment the secret device ID, web token, random seed, and a browser location into sections; and
include the segmented sections across the plurality of authentication tokens, wherein the segmented sections are included in different authentication tokens.

20. The system of claim 18, wherein the one or more processors are further configured to:
include the plurality of generated authentication tokens in the session cookie in the request sent to the web service.

21. The system of claim 18, wherein the one or more processors are further configured to:
include the plurality of generated authentication tokens in a header of the request, wherein the request is an HTTP/s request.

22. The system of claim 18, wherein the one or more processors are further configured to:
communicate the plurality of generated authentication tokens to the authentication server.

23. The system of claim 18, wherein the method is performed in response to a successful login by a user of the web browser to the web server.

24. The system of claim 18, wherein the received secret device ID and the web token are encrypted.

25. The system of claim 24, wherein the one or more processors are further configured to:
decrypt the received secret device ID and the web token using a symmetric key.

26. The system of claim 18, wherein the one or more processors are further configured to:
generate a new plurality of authentication tokens for each new request.

27. The system of claim 18, wherein the plurality of generated authentication tokens are ephemeral.

28. The system of claim 18, wherein the one or more processors are further configured to:
encrypt, using a symmetric key, the plurality of generated authentication tokens as the session cookie.

29. The system of claim 28, wherein the one or more processors, when validating the request, are configured to:
decrypt, using the symmetric key, the session cookie;
compare contents of the session cookie to information maintained by the authentication server, wherein the random seed included in the session cookie is compared to random seeds previously identified by the authentication server; and
determine the session cookie to be valid when the contents of the session cookie match the information maintained by the authentication server.

30. The system of claim 29, wherein the contents of the session cookie are a result of a challenge, a challenge includes at least a behavioral action by the browser.

31. The system of claim 29, wherein the one or more processors are further configured to:
receive a message forcing a user to re-log in when the session cookie is determined to be invalid.

32. The system of claim 18, wherein the request is at least an HTTP request directed to a web service hosted by the web server, the web service is a protected entity.

33. The system of claim 18, wherein embedding the first portion of the encryption and the second portion of the encryption key in a masked and compiled manner prevents the first portion and the second portion from being statically read within the WASM component.
